(19) United States
(12) Patent Application Publication
(10) Pub. No.: US 2024/0241645 A1
(43) Pub. Date: Jul. 18, 2024

(54) INSTRUCTION SET ARCHITECTURE AND HARDWARE SUPPORT FOR HASH OPERATIONS

(71) Applicant: Intel Corporation, Santa Clara, CA (US)

(72) Inventors: Robert Pawlowski, Beaverton, OR (US); Shruti Sharma, Beaverton, OR (US); Fabio Checconi, Fremont, CA (US); Sriram Aananthakrishnan, Lubbock, TX (US); Jesmin Jahan Tithi, San Jose, CA (US); Jordi Wolfson-Pou, Santa Clara, CA (US); Joshua B. Fryman, Corvallis, OR (US)

(21) Appl. No.: 18/621,437

(22) Filed: Mar. 29, 2024

(51) Int. Cl. G06F 3/06

(52) U.S. Cl. CPC G06F 3/0613; G06F 3/0656; G06F 3/0673

(57) ABSTRACT

Systems, apparatuses and methods may provide for technology that includes a plurality of hash management buffers corresponding to a plurality of pipelines, wherein each hash management buffer in the plurality of hash management buffers is adjacent to a pipeline in the plurality of pipelines, and wherein a first hash management buffer is to issue one or more hash packets associated with one or more hash operations on a hash table. The technology may also include a plurality of hash engines corresponding to a plurality of dynamic random access memories (DRAMs), wherein each hash engine in the plurality of hash engines is adjacent to a DRAM in the plurality of DRAMs, and wherein one or more of the hash engines is to initialize a target memory destination associated with the hash table and conduct the one or more hash operations in response to the one or more hash packets.

### GOVERNMENT LICENSE RIGHTS

This invention was made with government support under Contract No. W911NF-22-C-0081 awarded by Army Research Office and IARPA. The government has certain rights in the invention.

### BACKGROUND

Hash operations are ubiquitous and have many applications in artificial intelligence (AI), graph processing, and databases. Hash tables may be used for implementing associative arrays, with one example being a data structure to hold key-value pairs where values are associated with keys. Hash tables provide efficient store and lookup of such key-value pairs.

Prior approaches to performing hash operations may be purely software (SW) implementations. Software handles the hash operations by loading each entry of the hash table and scanning the valid key-value pairs for a match through repeated load and compare instruction loops until a match is found. Once the match is found, the hash entry contents are modified by software and stored back to the hash table memory. This “walking” of the hash table to find a matching pair may continuously load entries into the cache of the processor core, wherein software-based hash operations can exhibit poor performance due to various factors.

### BRIEF DESCRIPTION OF THE DRAWINGS

The various advantages of the embodiments will become apparent to one skilled in the art by reading the following specification and appended claims, and by referencing the following drawings, in which:

FIG. 1A is a slice diagram of an example of a memory system according to an embodiment;

FIG. 1B is a tile diagram of an example of a memory system according to an embodiment;

FIG. 2 is a flowchart of an example of a method of operating a memory system according to an embodiment;

FIG. 3 is a flowchart of an example of a method of handling wait instructions according to an embodiment;

FIG. 4 is a block diagram of an example of a hash management buffer according to an embodiment;

FIG. 5 is an illustration of an example of a memory line according to an embodiment;

FIG. 6 is an illustration of an example of a status field according to an embodiment;

FIG. 7 is a block diagram of an example of a hash engine according to an embodiment;

FIG. 8 is an operational flow diagram of an example of a hash engine execution unit according to an embodiment;

FIG. 9 is an operational flow diagram of an example of an initialization operation according to an embodiment;

FIG. 10 is an operational flow diagram of an example of an insert operation according to an embodiment;

FIG. 11 is an operational flow diagram of an example of a lookup operation according to an embodiment;

FIG. 12 is an operational flow diagram of an example of a delete operation according to an embodiment;

FIG. 13 is an operational flow diagram of an example of an unlock operation according to an embodiment;

FIG. 14 is a block diagram of an example of a performance-enhanced computing system according to an embodiment;

FIG. 15 is an illustration of an example of a semiconductor package apparatus according to an embodiment;

FIG. 16 is a block diagram of an example of a processor according to an embodiment; and

FIG. 17 is a block diagram of an example of a multi-processor based computing system according to an embodiment.

### DETAILED DESCRIPTION

As already noted, hash operations can be useful in artificial intelligence (AI) applications. For example, AI processes are designed to learn from observations. On new observations, AI processes frequently lookup values associated with old observations and update the underlying model. In Graph Convolutional Networks (GCN), hash tables are used in the graph sampling operation to determine whether a vertex or edge exists in the sampled set. In traditional graph analytics, hash tables are useful when storing information or properties about vertices and edges for quick lookups. For example, when counting triangles, a determination may be made as to whether the edge lists of two vertices ‘u’ and ‘v’ overlap. To make this determination, the edge list of ‘u’ can be stored in a hash table, wherein a lookup can be performed on the hash table using the edge list of ‘v’ to determine the common elements in the two edge lists.

Fundamental operations of the hash tables are insert, delete, and lookup. The insert operation adds a new key-value pair to underlying storage and the delete operation removes a key-value pair from the underlying storage. The lookup operation returns the associated value to a given key.

As also already noted, software-based hash operations may exhibit poor performance due to various factors. The first scenario of lost performance is the case where a high number of key-value pairs are scanned for a single hash operation. In each case, the pipeline will load the key-value pair, compare the key, and if there is not a match load the next key-value pair from the list.

Hiding memory latency through prefetching hash table entries is not straightforward, as the hash table is typically not built such that consecutive list entries are in adjacent addresses. Instead, the address of the next entry may not be known until the data of the previous entry has returned from memory. Prefetching many entries (e.g., regardless of which address is the next linked hash table entry) can provide some latency benefit in the event of the entire hash table being traversed. This approach risks, however, a significant amount of wasted bandwidth and energy from accessing and storing hash table entries in the cache that may not ultimately be utilized.

Another operation that has performance limitations is the deletion of hash table entries and the management of the pointers linking the various entries of the hash table. When the key of an element is matched on a deletion, the data is removed, the memory line is re-entered in a pool of free lines, and the pointer from the previous line is updated to not point to the deleted line. This process creates excess memory accesses to multiple memory lines of the hash table, and similar to the previous scenario, there are dependencies between the memory accesses preventing the use of common latency hiding techniques.

The performance limitations of these software-implemented hash operations may be known to be a common issue. Various hash procedures attempt to work around these bottlenecks by adjusting the organization of the hash tables and optimizing cache hit rates. In cases where the entire hash table fits in the cache, latency hiding becomes a smaller issue and the overall performance of the hash procedures benefits. This approach to reducing performance, however, is not viable in highly-scalable systems targeting workloads on large datasets due to the following reasons:
Larger datasets imply increased hash table sizes, limiting the benefits of caching because the data structures cannot fit fully in the caches.
Heavy multi-threading and shared memory among many cores may lead to concurrent accesses to hash table data structures. If all cores are pulling the hash table entries into their respective caches, heavy performance impacts may result from coherency traffic and data sharing. If operating directly on shared memory, further management of the hash table entries may be needed (e.g., lock/unlock), which adds additional software overhead and increases per-operation latency.

The technology described herein provides a scalable and efficient solution that allows for the use of hash tables to remain predominant in graph algorithms and other future AI workloads. The technology described herein also allows for software flexibility, while providing effective hardware (HW) that reduces software (SW) complexity and latency overheads of common hash table operations.

More particularly, embodiments provide a design for hardware acceleration of hashmap operations that are executed on hash tables organized in memory. The technology described herein provides instruction set architecture (ISA) extensions for programmability of the hash operations. The technology described herein also provides full hardware support—including near-memory compute—to execute functions such as inserting a key-value pair in a “bucket” (e.g., memory destination of a target hash table), deleting the key from the bucket, or finding a key in the bucket.

Providing hashmap operations as an ISA allows for improved software efficiency. Additionally, the implementation is done outside of the core cache hierarchy to enable improved efficiency through improved memory and network bandwidth utilization. The use of near-memory compute reduces total latency by eliminating extra network traversals and taking the shortest total path to all physical memory locations involved in the operation. Moreover, the technology described herein supports scalability through the handling of concurrent accesses to the same hash table with minimal performance impact.

More particularly, providing a hardware accelerated approach to hash operations reduces per-operation latency due to a lower number of traversals over the network to access the hash table. This benefit will grow under conditions where a single operation (e.g., insert, delete, etc.) involves many key comparisons before finding the matching hash entry. Additionally, implementations that use a single core to pull hash operations of a software-managed queue and solely access the hash table incur extra latency and software overhead for the queuing system. This hardware implementation removes those overheads.

Providing a hardware accelerated approach to hash operations also results in a higher number of outstanding hash table memory operations leading to higher memory bandwidth utilization. Atomic-only operations create serialization between long-latency operations from the pipelines to the hash table memory, which—when combined with a limited number of outstanding atomic operations per pipeline—places a limitation on the total requests to memory. The single-requesting core method is limited by the depth of the load-store queue of that core, which (e.g., dependent on cache hit rates) likely does not cover the round-trip latency to memory. Accordingly, such an implementation can quickly become latency bound.

Additionally, providing a hardware accelerated approach to hash operations reduces software overhead of hash table management. When using hash table data structures with no HW acceleration, resources are dedicated to managing hash table memory regarding the allocation of new entries and re-allocation of deleted entry memory. Typically, this dedication of resources is done using additional data structures per hash table. Each time the table is modified, SW accesses this data structure before modifying the hash table contents. This access will incur additional latency per hash operation due to additional memory accesses. The HW implementation described herein incorporates these data structures into a near-memory hash engine, which reduces total latency per operation.

As described herein, a Transactional Integrated Global-memory system with Dynamic Routing and End-to-end flow control (TIGRE) is a 64-bit Distributed Global Address Space (DGAS) solution for mixed-mode (e.g., sparse and dense) analytics at scale. TIGRE implements hash operations such as key-value insert, delete and lookup operations designed to address common primitives seen in graph algorithms.

Implementing hash operations in TIGRE involves a subsystem of specialized hardware near the pipelines and memory interfaces. Specifically, hash management hardware is made up of units that are local to the pipeline as well as in front of all scratchpad and DRAM interfaces.

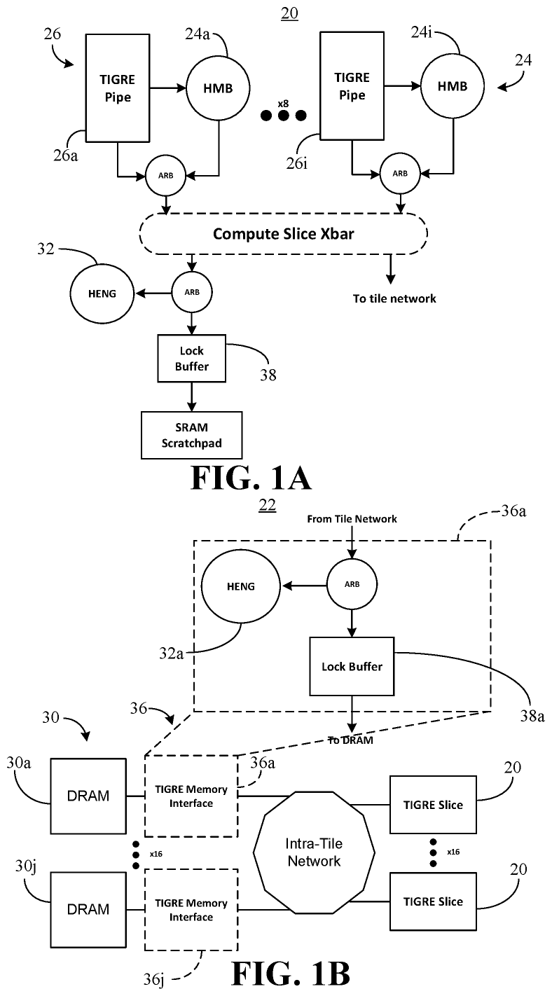

Turning now to FIGS. 1A and 1B, a TIGRE slice 20 diagram and a TIGRE tile 22 diagram are shown, respectively. FIGS. 1A and 1B show the lowest levels of the hierarchy of the TIGRE system. More particularly, the TIGRE slice 20 includes a plurality of hash management buffers 24 (HMBs, 24a-24i) corresponding to a plurality of pipelines 26 (26a-26i), wherein each HMB 24 is adjacent to a pipeline in the plurality of pipelines 26. The illustrated TIGRE tile 22 includes sixteen local dynamic random access memory (DRAM) channels 30 (30a-30j).

The HMB 24 is pipeline-local unit that receives hash instructions from the pipeline 26 as the ISA is issued. The HMB 24 tracks the completion of the insert, lookup, delete and unlock hash instructions and manages “wait” instructions for the purpose of fencing the pipeline 26 until completion of the hash operation. Hash engines 32 (32a-32j, not shown, e.g., HENGs) are positioned adjacent to memory interfaces 36 (36a-36j) and receive hash packets from the HMBs 24. The HMBs 24 determine the physical memory destination and the hash packets (e.g., including forward instruction requests) to the appropriate near-memory HENG 32.

The HENG 32 is a near memory unit responsible for executing the hash insert, lookup, delete and unlock operations. The HENG 32 receives the instruction packet from the HMB 24, obtains the base address for the hash table from MSRs (machine specific registers) of the HENG 32, and performs the insert, lookup, delete and unlock operations through load and store operations to the local memory of the HENG 32. After the operations are complete, the HENG 32 creates a write request packet to update the result address with a status and data pointer.

Lock buffers 38 (38a-38j, not shown) are located before each memory port and maintain line-lock status of the address behind the memory port. The lock buffer 38 may also support remote atomic operations. As part of the support of the hash operations, the HENG 32 uses read-lock and write-unlock capability to avoid conflicting accesses to hash table entries.

Unique aspects of the TIGRE slice 20 and the TIGRE tile 22 architecture include software programmability by definition of a custom ISA for each hash operation type. Additionally, MSRs in the HENG 32 and HMB 24 allow for programmability of hash table characteristics. Additionally, the functionality of the pipeline-local HMB 24 is unique. This functionality includes the capability to determine the memory destination of the target hash table based on a given bucket identifier (ID). The HMB 24 functionality also includes the management of in-flight requests and exposure of operation statuses to programmers with non-blocking (e.g., “h.poll”) and blocking (e.g., “h.wait”) instruction support. Moreover, the functionality of the near-memory HENG 32 includes a description of instruction flows within the engine and the interaction between the engine and the local memory. Additional information includes MSR definitions, details of hash entry management and organization, and internal engine architecture and functional behavior.

### TIGRE Hash Map ISA

Hash map operations are performed using the hash instructions listed in Table I. Hash instructions are integrated into the ISA of the pipeline 26 and passed from the pipeline 26 to the local HMB 24. The arguments listed are not all described in detail within the table.

TABLE I

| | ISA | |
|---|---|---|
| Instruction | Arguments | Instruction Description |
| h.init | r1 = Hash ID, | Initializes a pre-allocated hash table |
| | r2 = Bucket ID | memory region for a given bucket ID |
| | | (r2) and hash ID (r1). This instruction |
| | | must be issued before any other hash |
| | | engine instructions are issued targeting |
| | | this bucket ID |
| h.insert | r1 = Hash ID, | Inserts a key-value pair into a given |
| | r2 = Bucket ID, | bucket ID (r2) and hash ID (r1). If the |
| | r3 = Key, | key (r3) already exists in the bucket, the |
| | r4 = Data Ptr, | data pointer (r4) is stored in the value, |
| | r5 = Result | and the pre-existing data pointer is |
| | Addr, RVAL, | written to result address (r5). If the key |
| | Lock, | is not found, a new element is allocated |
| | vector[7:0] | for the key value pair. |
| h.lookup | r1 = Hash ID, | Checks if the key (r3) exists in the |
| | r2 = Bucket ID, | given bucket ID (r2) and Hash ID (r1). |
| | r3 = Key, | If the key exists, the data pointer |
| | r4 = Result | associated with the key is returned to |
| | Addr, | the result address (r4). If no key match |
| | RVAL, Lock, | is found, the result address is updated |
| | vector[7:0] | with “not found” status. |
| h.delete | r1 = Hash ID, | Deletes a key (r3) from a given bucket |
| | r2 = Bucket ID, | ID (r2) and hash ID (r1). If the key is |
| | r3 = Key, | found, the element is marked as invalid, |
| | r4 = Result | and the result address (r4) is updated |
| | Addr, RVAL, | with the old value and an indication of |
| | vector[7:0] | “success”. |
| h.unlock | r1 = Hash ID, | Unlocks a key-value pair matching a |
| | r2 = Bucket ID, | given key (r3) for the given bucket ID |
| | r3 = Key, | (r2) and hash ID (r1). Key-value pairs |
| | r4 = Unused, | can be locked as part of execution of |
| | r5 = Result | other hash instructions. |
| | Addr, RVAL, | |
| | unused, | |
| | vector[7:0] | |
| h.wait | r1 = Hash ID | Stalls forward execution of the thread |
| | | in the pipeline until the operations |
| | | launched by that thread for a given hash |
| | | ID (r1) have completed. |
| h.poll | r1 = Hash ID, | Non-blocking method to check status of |
| | r2 = register to | hash operations for the given hash ID |
| | receive status | (r1). |
| h.waitall | | Stalls forward execution of the thread |
| | | until all hash operations launched by |
| | | that thread have completed. |

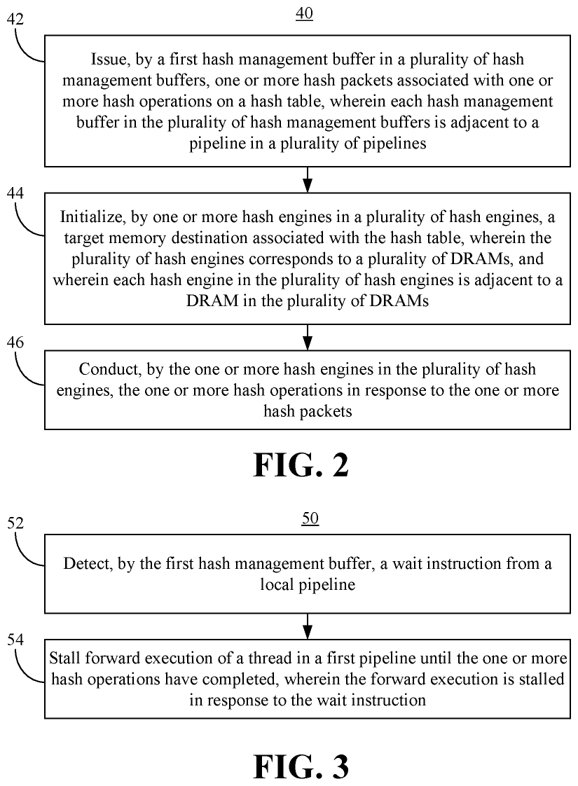

FIG. 2 shows a method 40 of operating a memory system. The method 40 may generally be implemented in a memory system slice such as, for example, the TIGRE slice 20 (FIG. 1A) and/or a memory system tile such as, for example, the TIGRE tile 22 (FIG. 1B), already discussed. More particularly, the method 40 may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Computer program code to carry out operations shown in the method 40 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 42 provides for issuing, by a first hash management buffer (HMB) in a plurality of hash management buffers, one or more hash packets associated with one or more hash operations on a hash table, wherein each hash management buffer in the plurality of hash management buffers is adjacent to a pipeline in a plurality of pipelines. In one example, the hash packet(s) are issued in response to one or more hash instructions (e.g., ISA instructions) from a local pipeline. As will be discussed in greater detail, the hash operation(s) can include an insert operation to insert a key-value pair into a target memory destination (e.g., bucket) associated with the hash table, a lookup operation to determine whether a key exists in the target memory destination, a delete operation to delete a key from the target memory destination, an unlock operation to unlock a key-value pair matching a key associated with the hash table, and so forth.

Block 44 initializes, by one or more hash engines (HENGs) in a plurality of hash engines, the target memory destination associated with the hash table, wherein the plurality of hash engines corresponds to a plurality of DRAMs, and wherein each hash engine in the plurality of hash engines is adjacent to a DRAM in the plurality of DRAMs. Block 46 conducts, by the one or more hash engines in the plurality of hash engines, the one or more hash operations in response to the one or more hash packets.

FIG. 3 shows a method 50 of handling wait instructions. The method 50 may generally be implemented in conjunction with the method 40 (FIG. 2), already discussed. More particularly, the method 50 may be implemented in one or more modules as a set of logic instructions stored in a machine- or computer-readable storage medium such as RAM, ROM, PROM, firmware, flash memory, etc., in hardware, or any combination thereof.

Illustrated processing block 52 detects, by the first hash management buffer, a wait instruction from a local pipeline. Block 54 stalls forward execution of a thread in a first pipeline until the one or more hash operations have completed, wherein the forward execution is stalled in response to the wait instruction. As will be discussed in greater detail, the hash operation(s) can be associated with a single hash ID (e.g., “h.wait” instruction causes a pipeline fence to be asserted only until hash instructions corresponding to a particular hash ID are complete) or a plurality of hash IDs (e.g., “h.wait” instruction causes a pipeline fence to be asserted until all hash instructions are complete).

### Hash Management Buffer

As already noted, each pipeline has a local HMB that calculates the target memory address (e.g., and target HENG) for each hash operation. Additionally, the HMB maintains the completion status for each operation to quickly respond to h.wait and h.poll instructions.

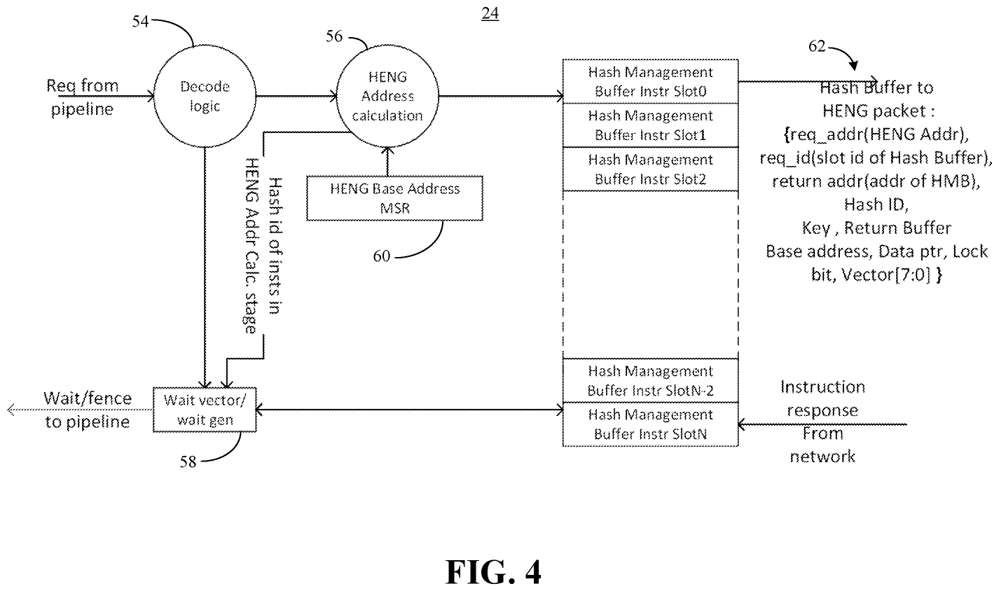

FIG. 4 shows a block diagram of the proposed internal organization of an HMB 24. In the illustrated example, the HMB 24 receives the instruction from the pipeline and sends the instruction to decode logic 54 (e.g., including logic instructions, configurable hardware, fixed-functionality hardware, etc., or any combination thereof). The instruction is either sent to an HENG address calculation stage 56 or to the wait generation logic 58.

For insert, lookup, delete and update instructions, the HMB 24 uses a HENG base address MSR 60 (e.g., programmed by SW) and the bucket ID field of the instruction to create a request address field of a network packet 62. The HENG base address MSR 60 contains the job physical base address for all HENG units and the bucket ID acts as an offset to generate the target address of the specific bucket within the hash table. Instructions are then marked as complete after receiving the instruction response from the HENG that executed the operation. For each instruction sent out to a HENG, the HMB 24 receives one response.

For wait instructions, no HENG address is calculated and the instruction is sent to the wait generation logic 58. If a h.waitall instruction is received by the HMB 24, a pipeline fence is asserted until all the hash instructions are complete. If a h.wait instruction is received for a specific Hash ID, a pipeline fence is asserted only until hash instructions belonging to the particular hash ID are complete. The wait vector in the wait generation logic 58 is a bit vector that indicates which hash IDs have operations “in-flight” (e.g., not yet completed). For the h.waitall instruction, all the instructions in the HMB 24 slots are tracked for completion regardless of hash ID.

### Hash Engine

The HENG is a near memory unit that is responsible for executing the hash insert, lookup, delete and unlock operations. The HENG involves MSR details, hash entry memory line organization, and processes to manage hash table memory.

### HENG MSRs

The HENG uses the information from local MSRs to obtain the address location of the local hash table and perform insert, delete, lookup or unlock operations through load stores operations to memory. Table II lists the MSRs included in each HENG.

TABLE II

| Name | Description |
|---|---|
| Hash Table Base | Canonical address of the physical local memory |
| Address | region that that hash table presides at. |
| Hash Table Size | Total number of bytes allocated to the hash table |
| | in the local memory. |
| Bucket Size | Size in bytes of a single bucket. Used for |
| | calculating each bucket ID's base address. |
| Load Factor | Number of hash table elements that one operation |
| | should access before the HENG ends the operation |
| | with a ‘fail-load factor reached’ status. |
| Next Open | Canonical address of the next available memory |
| Address | line to use when allocating a list element. |

### Organization of Hash Entries in Memory

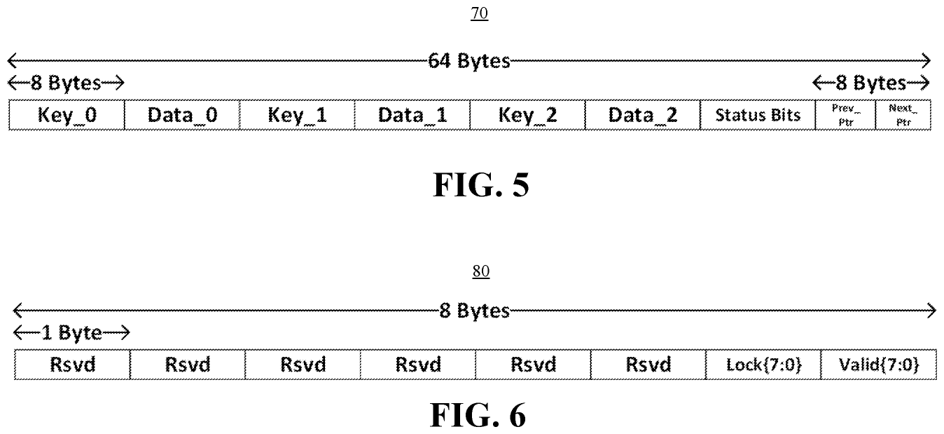

FIG. 5 demonstrates that the organization of the hash element data and key values in the local memory guides the HW behavior within the hash engine. In the illustrated example, a memory line 70 is located in a 64-byte aligned portion of the local memory. Each group of three list elements is included within the same 64-byte line. The fields are:
Key_{2:0}—64-bit value to be compared against the key value received with the hash operation request. Each 64-Byte list line includes up to three key values for three separate elements.
Data_{2:0}—64-bit pointer to the data associated with the same numbered element of the key value.
Status Bits—Valid and lock bit information for the three entries in the 64-Byte data line.
Prev_Ptr—32-bit pointer of the local memory address of the 64-Byte line that contains the previous three elements in the list of the bucket.
Next_Ptr—32-bit pointer of the local memory address of the 64-Byte line that contains the next three elements in the list of the bucket OR to the next empty memory address to be allocated on a new h.insert operation.

FIG. 6 demonstrates that the status field 80 of the memory line 70 (FIG. 5) includes valid and lock information for each of the three entries in the memory line 70 (FIG. 5).

### Tracking Open Memory Lines for Hash Element Allocation

When an h.insert operation is received by the HENG, the engine scans the list of elements for the bucket ID across all linked memory addresses. If there is no match of the key value with any currently stored keys in the list, the HENG finds an open memory line to store the inserted key and data pointer. When an h.delete operation is received by the HENG, the key and data pointer are deleted, and that element slot is freed for re-use. If the entire memory line is empty, the memory line is freed for re-use by any bucket ID. The design approach to tracking the available memory lines is as follows.

Open memory lines are tracked by creating a linked list among the lines. When a memory line is not occupied by valid elements, the Next_Ptr field is used to point to the next free memory line in the list. An open memory line is indicated as such by having all bits in the Valid subfield of the Status field equal to zero. The address of the first memory line in the list is stored in an HENG MSR.

Memory lines are allocated to valid key/data pairs as h.insert operations are received by the HENG. When this instruction is received, a free memory line is pulled from the list and allocated once the following conditions are met:
The HENG did not find a match among all valid elements across the list of memory lines allocated to that bucket ID.
The final memory line in the list does not have any available element slots (e.g., there are already three key/data pairs occupying the memory line).

If these conditions are met, the HENG retrieves/pulls the base address of the next free 64-Byte memory line from the HENG MSR. The HENG reads that line from memory and then writes the address from the Next_Ptr field of the read memory line into the HENG MSR (e.g., this address is now the next list value to be used). At this juncture, the free memory management portion of the operation is completed and the HENG proceeds in memory line modifications according to the operations given with respect to the h.insert flow.

### Hash Engine Architecture

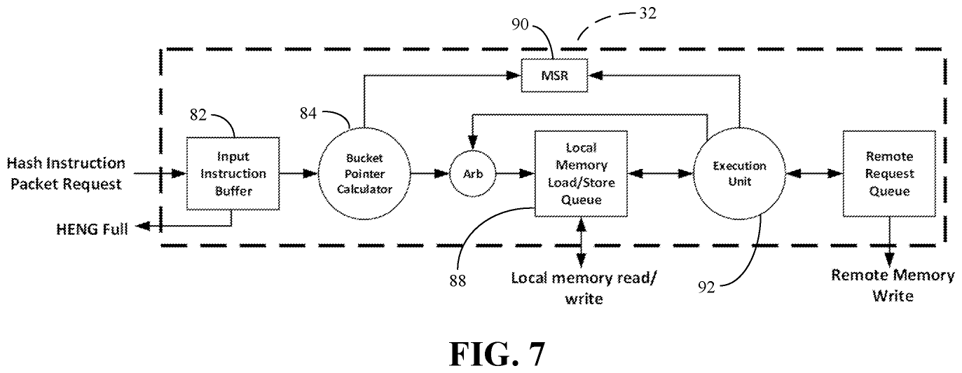

FIG. 7 shows the internal architecture of the near-memory HENG 32. A brief description of each unit in the HENG 32 is as follows. An input instruction buffer 82 is an input queue for instructions received from the HMB. This queue being full indicates to the requestor that a retry (from the local MTB) is to be performed. **INVENTORS—WHAT DOES “MTB” STAND FOR?*** A bucket pointer calculator 84 returns the base memory address of the bucket for a given bucket ID and hash ID. Additionally, a key comparison unit (not shown) may execute the comparison between loaded key values and the provided key values.

### Input Instruction Buffer

The input instruction buffer 82 includes per-slot storage and operates as a first in first out (FIFO) buffer. More particularly, the input instruction buffer 82 accepts hash instructions from various HMBs throughout the system, routes the instruction to the proper execution engine based on availability, queues up instructions when all execution engines are occupied, provides back-pressure to the requesting side, and initiates retries from the local MTB. The per-slot storage breakdown is shown in Table III. The size of each slot is determined by the information received as well as the address of the sending HMB. In one example, there are 219 total bits per slot.

TABLE III

| | | Width |
|---|---|---|
| Name | Description | (bits) |
| Req ID | HMB Request ID | 6 |
| HENG | Opcode of hash instruction | 4 |
| Instruction | | |
| Opcode | | |
| Return Address | Address of the HMB that the packet was | 64 |
| | received from | |
| Bucket ID | Hash Bucket ID that I the target of the | 8 |
| | operation | |
| Key Value | Key Value for compare within the hash | 64 |
| | operation | |
| Return Buffer | Base address for data return from the | 64 |
| Base Address | hash operation | |
| Lock Bit | Locks the hash entry during execution | 1 |
| | of the operation | |
| Vector | Indicates that the hash operation input | 8 |
| | keys and data are vectorized | |

Once an instruction is at the front of the queue—and the next stage is ready to receive the instruction—the full 219 bits are passed to the bucket pointer calculator 84.

### Bucket Pointer Calculator

As shown in the HENG flow charts, the bucket pointer calculation outputs the base address of the bucket targeted by the received hash instruction. This calculation is performed once for each instruction that is executed in the HENG. The bucket pointer calculation block takes in the bucket ID as part of the received instruction. The pointer is calculated using this received value and two MSR 90 values: the hash table base address and the bucket size. Once a request is initiated at the bucket pointer calculator 84 from an execution unit 92, the following operations are performed:
the hash table base address pointer (e.g., in the local memory space) is retrieved from the MSR 90 (see Table III)
the bucket size pointer (e.g., in the local memory space) is retrieved from the MSR 90 (see Table III)
the bucket ID value received with the instruction is considered an offset from the hash table base address. Therefore, the bucket base address pointer is determined by the following equation:

$$( ID * Bucket\_Size + Hash\_Table \_Base \_Address )$$

Once the bucket pointer calculation is complete, the address—along with the 219 bit packet received from the input instruction buffer—is sent to a HENG local memory load/store queue 88 for the list entries to be loaded for key comparison.

### Local Memory Load/Store Queue

A local memory load/store queue (LSQ) 88 holds requests that are loading and storing hash table memory lines from/to the local memory. Table IV lists the contents of a single entry of the local memory LSQ 88. The depth of the LSQ 88 is determined based on the average latency of the local memory requests.

TABLE IV

| Field | Width (bits) |
|---|---|
| Store Data | 512 |
| Target Address | 32 |
| HENG Instruction Opcode | 4 |
| Instruction Load Count | 64 |
| Return Address | 64 |
| Req ID | 6 |
| Key Value | 64 |
| Return Buffer Base | 64 |
| Address | |
| Lock Bit | 1 |
| Vector | 8 |

The LSQ 88 holds a slot while the memory request is outstanding. Once the request returns, the LSQ 88 sends the full instruction (e.g., plus data if the request was a load) to an execution unit 92 with an indication that the local memory request was a load or store—this operation will affect the resulting behavior in the execution unit 92.

### Execution Unit

The execution unit 92 is responsible for the following operations of the HENG instruction flows:
Comparing the key(s) loaded from the memory line storing the hash list elements.
Comparing the line access count for the current instruction to the “Load Factor” MSR 90.
Constructing requests to the local memory LSQ according to the HENG instruction flows.
Constructing requests to the remote memory upon operation completion according to the HENG instruction flows.

The execution unit 92 receives packets from the local memory LSQ 88. These packets will include the fields shown in Table V. Many of the fields in Table V are the same as information held in the previous stages of the HENG. Those fields are repeated here for completeness and to facilitate discussion.

TABLE V

| Field | Description |
|---|---|
| Table Entry Data | 64-byte memory line holding hash table entries. |
| | Returned from load that was just in the LSQ. |
| Current Target | Most recent local memory address that was |
| Address | accessed |
| HENG Instruction | Opcode of hash instruction |
| Opcode | |
| Memory Access | Number of times hash entries in memory have |
| Count | been accessed while servicing this instruction. |
| Return Address | Address of the HMB that the packet was |
| | received from |
| Req ID | HMB Request ID |
| Key Value | Key Value (from HMB) for compare within |
| | the hash operation |
| Return Buffer | Base address for data return from the hash |
| Base Address | operation |
| Lock Bit | Indicates that hash entry will be locked as |
| | conclusion of operation |
| Vector | Indicates that the hash operation input keys and |
| | vectorized data are |

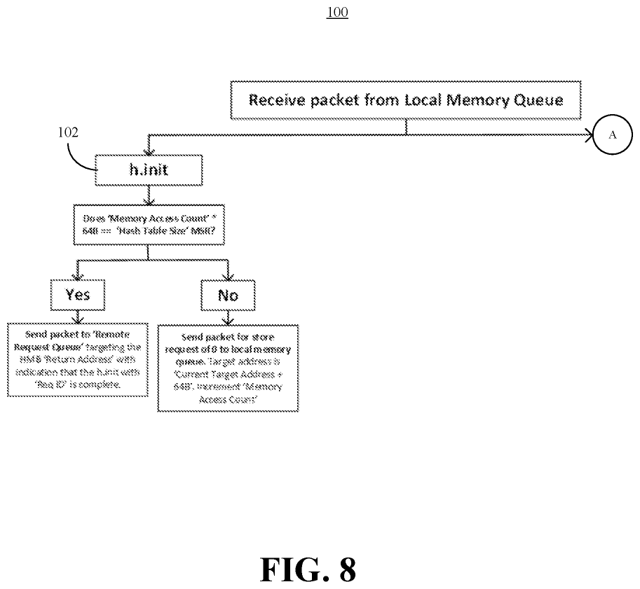

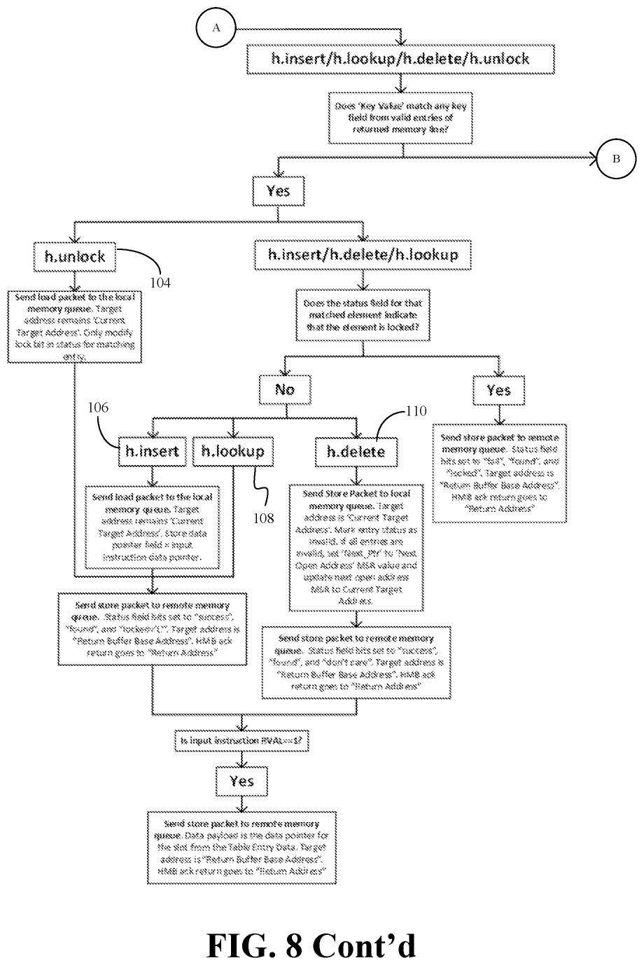

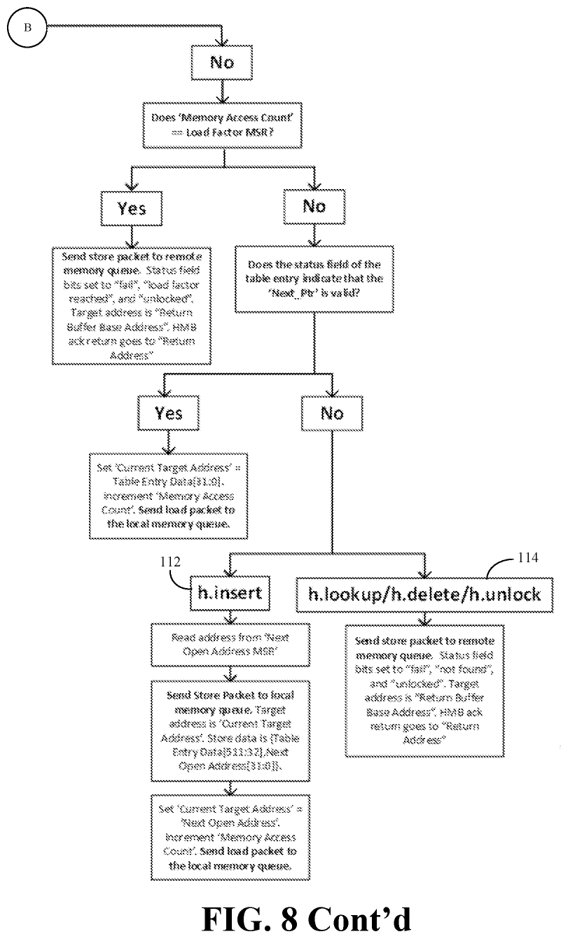

FIG. 8 shows an operational flow diagram 100 to be performed by the execution unit once a request is received from the local memory LSQ. This diagram 100 shows the decision tree that the execution unit takes based on the contents of the memory line that have been read and the input instruction that passes through the HENG stages. The diagram 100 includes an initialization decision path 102, an unlock decision path 104, a first insert decision path 106, a lookup decision path 108, a delete decision path 110, a second insert decision path 112, and a combination decision path 114. The design of the HENG provides for the full instruction information to pass from stage to stage, such that once the execution unit works through the flow diagram to eventually send the packets to the local memory queue or remote memory queue, execution of that particular instruction for that phase has completed, and the execution unit resources are free to operate on the next request received from the local memory queue.

### Hash Engine Instruction Flows

For all custom h.* instructions, the arguments from the pipeline ISA (e.g., shown in Table I) are sent to the HENG. A summary of all possible arguments is as follows. Note that some instructions utilize only a subset of the arguments summarized below. The arguments used by each instruction will be listed in each respective subsection.
Hash ID (r1)—64-bit value identifying the target hashmap (e.g., hash table). This identifier is used for determining physical memory location of the target hashmap (e.g., the region of the physical memory to which the Hash ID is allocated).
Bucket ID (r2)—64-bit value for identifying the target bucket within the Hash ID. This argument is used by the HENG to find the base address value to begin scanning of the hash list entries.
Key (r3)—64-bit value for comparison with the keys stored in the hashmap.
Data Pointer (r4)—64-bit pointer (virtual address) to the data value (or values) associated with the key value in a particular hash element entry. This pointer may be to memory that is remote from the hash table memory.
Result Address (r5)—Pointer (Virtual address) to the memory location where the result of the insert operation is sent. The result information includes “pass/fail”, “found/not found”, “locked”, and the old data pointer (if RVAL==1).
RVAL—A 1-bit option. If set to 1, the previous data pointer preceding the insertion is stored at the result address.
Lock—A 1-bit option. If set to 1, the key-value pair is locked following the insertion. This lock is done by marking the associated “lock” bit in the hashmap memory entry.
Vector[7:0]—Indicates that an array of data pointers will be associated with the key value in the hash table element. If greater than one, the data pointer in the hash list points to a list of pointers to each respective data field. This argument adds an additional level of indirection but provides support for multimaps.

### Hash Table Initialization

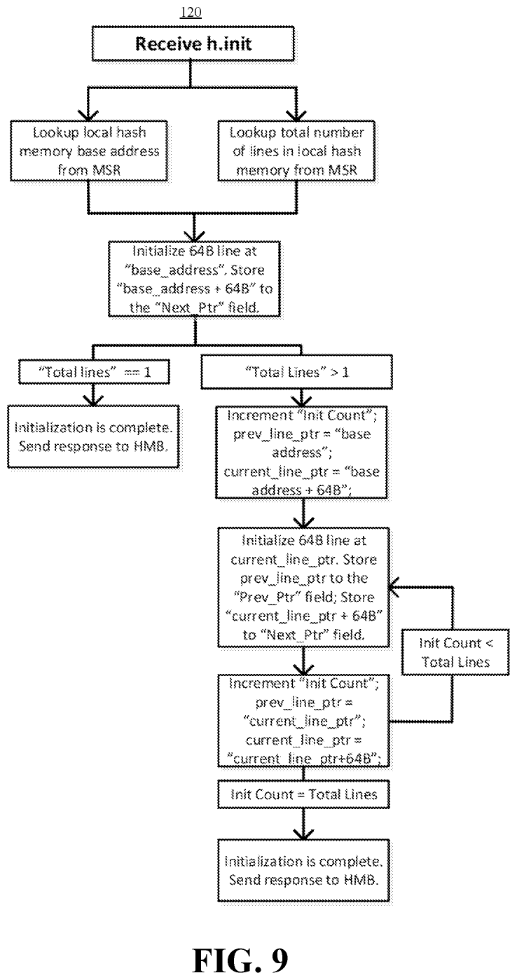

FIG. 9 shows an operational flow diagram 120 demonstrating that before use of the hash acceleration operations, the hash table memory region is properly initialized by the HENG. This initialization is done using a custom h.init instruction. This instruction delivers the base memory address of the hash table, as well as the total number of 64-Byte memory lines that will be allocated for hash table usage.

More particularly, the h.init instruction initializes a pre-allocated hash table memory region for a given bucket ID and hash ID. This instruction is issued before any other hash engine instructions are issued targeting this bucket ID. The h.init instruction initializes the entire hash memory behind that memory port by starting from a preset base address stored in a local MSR. The HENG then steps through each 64-Byte line of the hash memory—from the base address until “base address+(64B*total_num_lines)” and initializes the pointers in each line. Once the initialization is complete, the base address is stored in the MSR indicating the next line to allocate, and each 64-Byte memory line in the hash memory will include pointers to the previous and next memory lines in the list of free memory lines.
h.init R1, R2

$$r 1 = Hash ID ,$$

$$r 2 = Bucket ID$$

### Hash Table Usage

This subsection describes the various functionalities supported by the HENG for typical hash acceleration operation. Each subsection will cover a different operation with flow diagrams.

### Hash Insertion

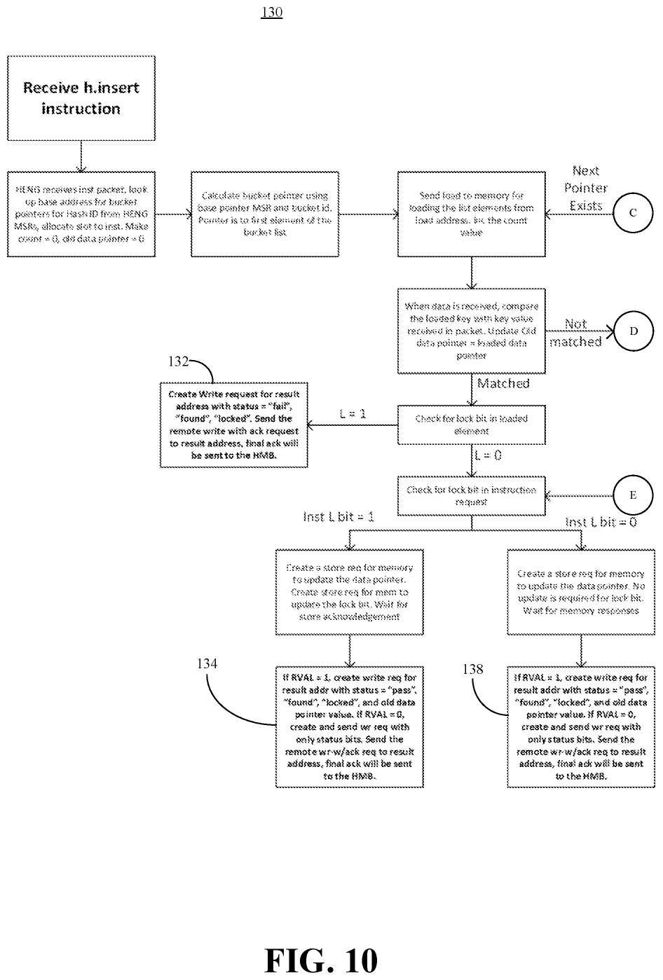

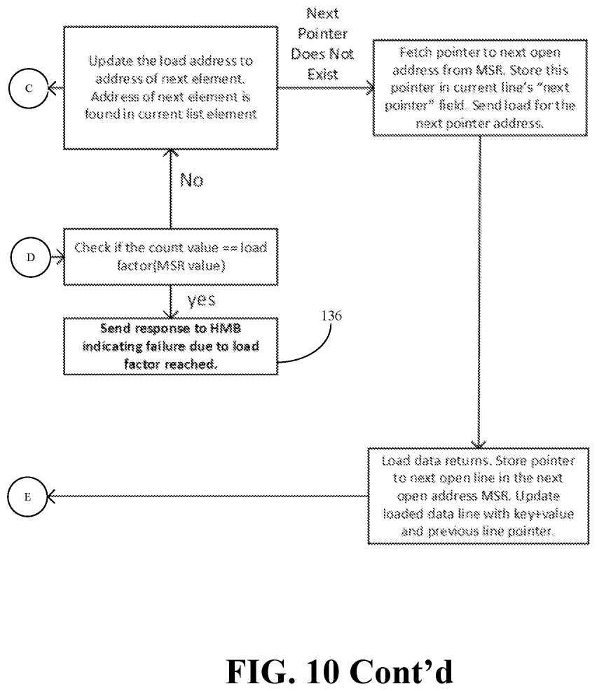

FIG. 10 shows an operational flow diagram 130 demonstrating that the h.insert instruction is used to insert a key value pair in the bucket ID given in ISA instruction. The key may already exist in the hash map, and therefore the HENG scans the hash map entries of the bucket ID to determine whether the key exists. If the key does not, the HENG will store the key-value pair into the first found empty slot in the list of the bucket ID.

A description of the h.insert instruction and corresponding arguments for the h.insert instruction is provided below. Conclusion blocks 132, 134, 136 and 138 indicate operations of the flow diagram 130 that are conclusions of the instruction within the HENG.
h.insert R1, R2, R3, R4, R5, RVAL, Lock, Vector[7:0]

$$r 1 = Hash ID ,$$

$$r 2 = Bucket ID ,$$

$$r 3 = Key ,$$

$$r 4 = Data Ptr ,$$

$$r 5 = Result Addr ,$$

$$RVAL ,$$

$$Lock ,$$

$$vector [ 7 : 0 ]$$

### Hash Lookup

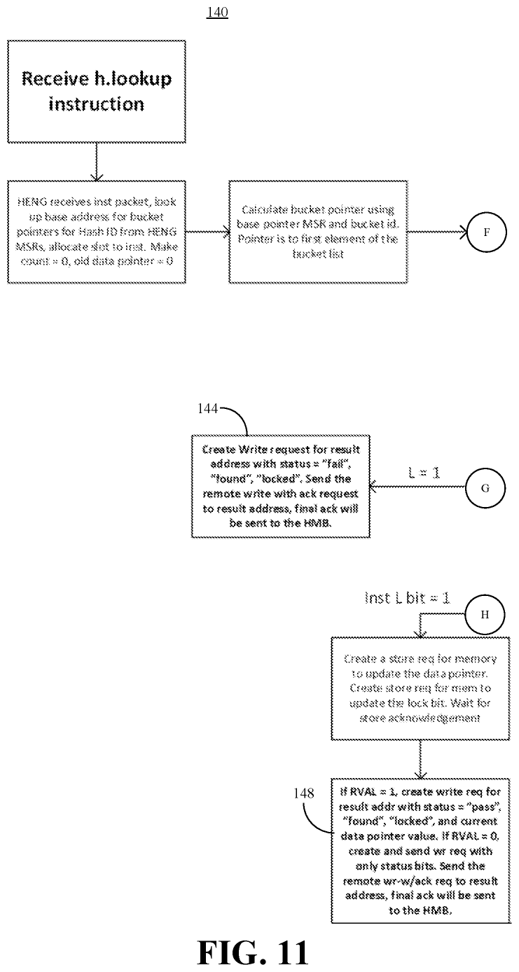

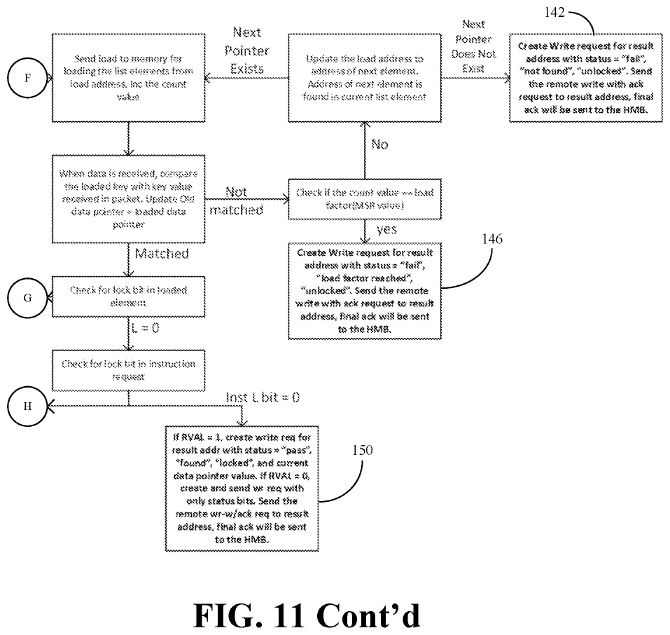

FIG. 11 shows an operational flow diagram 140 demonstrating that the h.lookup instruction searches for a key match (e.g., provided in r3) in a given bucket (e.g., ID provided in r2). Following the execution of this operation in the HENG, the address location given in r4 is updated with an indication that a match was found. The h.lookup operation does not modify the current contents of the hash table.

A description of the h.lookup instruction and corresponding arguments is provided below. Conclusion blocks 142, 144, 146, 148 and 150 indicate operations of the flow that conclude the execution of the instruction within the HENG.

h.lookup R1, R2, R3, R4, R5, RVAL, Lock, Vector[7:0]

$$r 1 = Hash ID ,$$

$$r 2 = Bucket ID ,$$

$$r 3 = Key ,$$

$$r 4 = Data Ptr ,$$

$$r 5 = Result Addr ,$$

$$RVAL ,$$

$$Lock ,$$

$$vector [ 7 : 0 ]$$

### Hash Delete

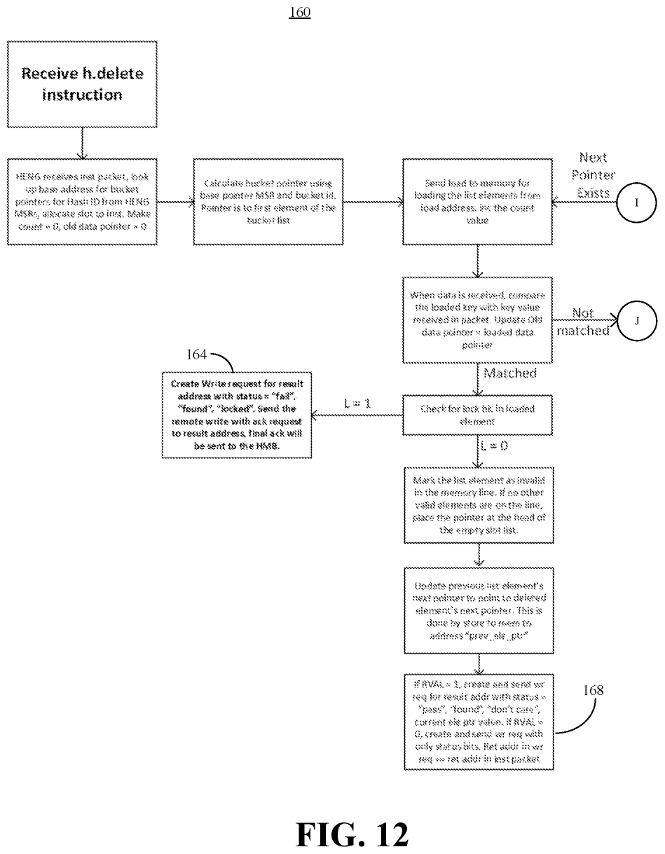

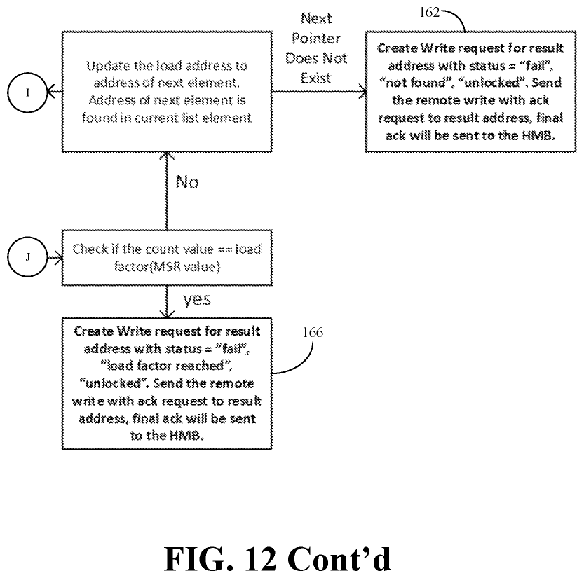

FIG. 12 shows an operational flow diagram 160 demonstrating that the h.delete instruction scans the target hash table bucket for a match to the user-provided key. If that match is found, the key-value pair stored at that element is deleted. An option is provided to return the data pointer associated with the key along with the result of the delete operation (found/not found).

The h.delete instruction arguments are listed below. Conclusion blocks 162, 164, 166 and 168 indicate operations of the flow that conclude the execution of the instruction within the HENG.
h.delete R1, R2, R3, R4, RVAL, Vector[7:0]

$$r 1 = Hash ID ,$$

$$r 2 = Bucket ID ,$$

$$r 3 = Key ,$$

$$r 4 = Result Addr ,$$

$$RVAL ,$$

$$vector [ 7 : 0 ]$$

### Hash Unlock

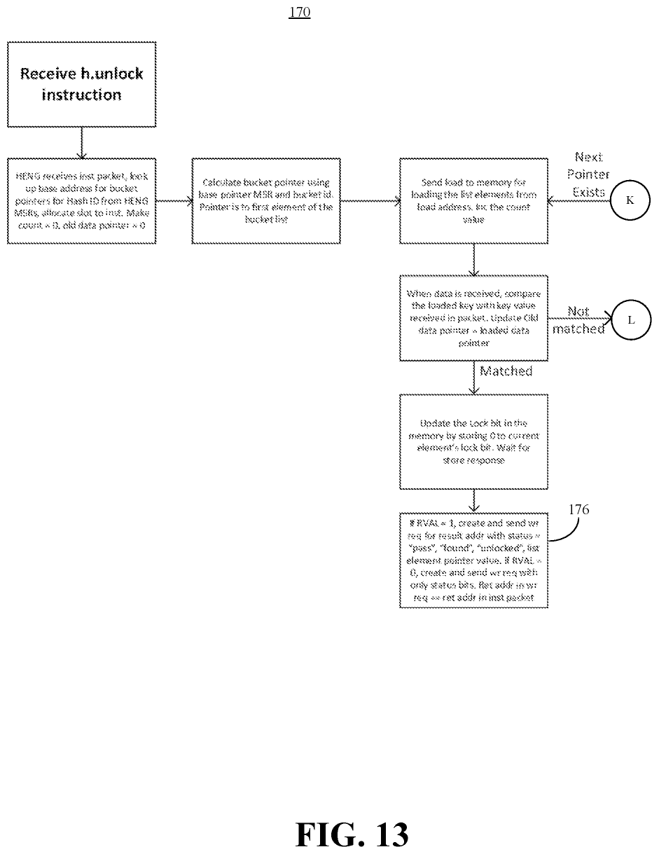

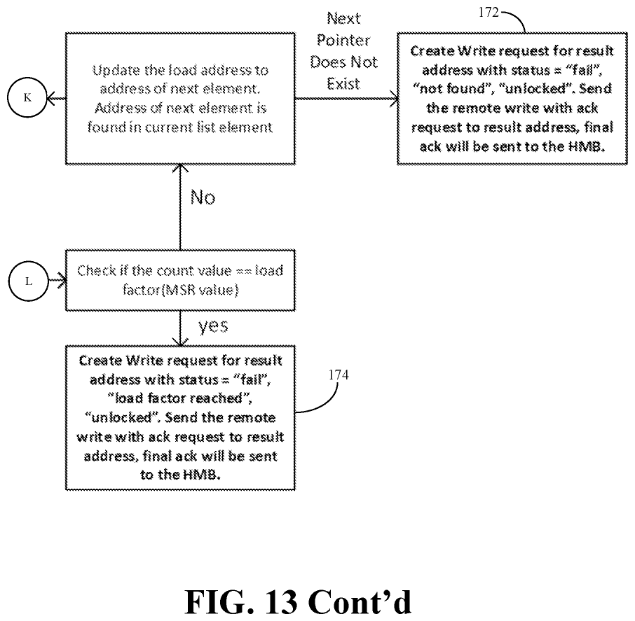

FIG. 13 shows an operational flow diagram 170 demonstrating that the h.unlock instruction unlocks a key-value pair that is currently locked from a previous operation. The HENG scans the target hash table bucket for a match to the user-provided key. If that match is found, the key-value pair stored at that element is unlocked. If the key-value pair was not previously locked, this operation leaves the status of the element unchanged. An option is provided to return the data pointer associated with the key along with the result of the unlock operation (e.g., found/not found).

The h.unlock instruction arguments are listed below. Conclusion blocks 172, 174 and 176 indicate operations of the flow that conclude the execution of the instruction within the HENG.
h.unlock R1, R2, R3, R4, RVAL, Vector[7:0]

$$r 1 = Hash ID ,$$

$$r 2 = Bucket ID ,$$

$$r 3 = Key ,$$

$$r 4 = Result Addr ,$$

$$RVAL ,$$

$$vector [ 7 : 0 ]$$

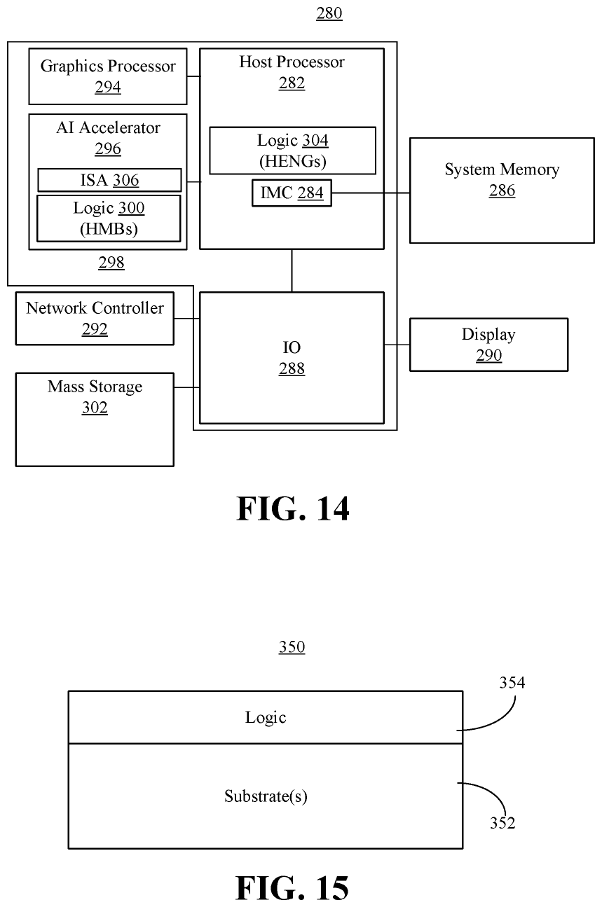

Turning now to FIG. 14, a performance-enhanced computing system 280 is shown. The system 280 may generally be part of an electronic device/platform having computing functionality (e.g., personal digital assistant/PDA, notebook computer, tablet computer, convertible tablet, edge node, server, cloud computing infrastructure), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof.

In the illustrated example, the system 280 includes a host processor 282 (e.g., central processing unit/CPU) having an integrated memory controller (IMC) 284 that is coupled to a system memory 286 (e.g., dual inline memory module/DIMM including a plurality of DRAMs). In an embodiment, an IO (input/output) module 288 is coupled to the host processor 282. The illustrated IO module 288 communicates with, for example, a display 290 (e.g., touch screen, liquid crystal display/LCD, light emitting diode/LED display), mass storage 302 (e.g., hard disk drive/HDD, optical disc, solid state drive/SSD) and a network controller 292 (e.g., wired and/or wireless). The host processor 282 may be combined with the IO module 288, a graphics processor 294, and an AI accelerator 296 (e.g., specialized processor) into a system on chip (SoC) 298.

In an embodiment, the AI accelerator 296 includes an ISA 306 to issue one or more instructions to conduct one or more hash operations (e.g., insert, lookup, delete, unlock, etc.) hash management buffer (HMB) logic 300 and the host processor 282 includes hash engine (HENG) logic 304, wherein the logic 300, 304 (e.g., performance-enhanced memory system) performs one or more aspects of the method 40 (FIG. 2) and/or the method 50 (FIG. 3), already discussed. Thus, the HMB logic 300 includes a plurality of hash management buffers corresponding to a plurality of pipelines, wherein each hash management buffer in the plurality of hash management buffers is adjacent to a pipeline in the plurality of pipelines, and wherein a first hash management buffer is to issue one or more hash packets associated with the one or more hash operations on the hash table. The HENG logic 304 includes a plurality of hash engines corresponding to a plurality of DRAMs in the system memory 286, wherein each hash engine in the plurality of hash engines is adjacent to a DRAM in the plurality of DRAMs, and wherein one or more of the hash engines is to initialize a target memory destination associated with the hash table and conduct the hash operation(s) in response to the hash packet(s).

FIG. 15 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. In an embodiment, the logic 354 implements one or more aspects of the method 40 (FIG. 2) and/or the method 50 (FIG. 3), already discussed, and may be readily substituted for the logic 300, 304 (FIG. 14), already discussed.

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

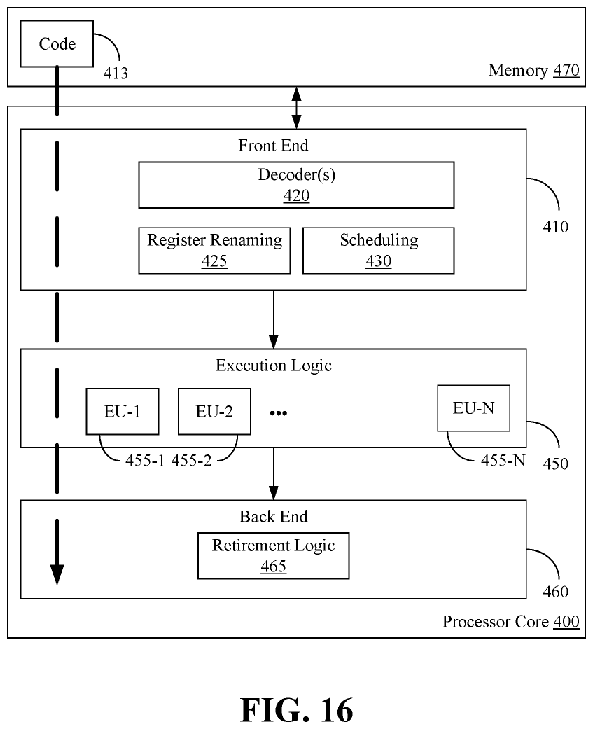

FIG. 16 illustrates a processor core 400 according to one embodiment. The processor core 400 may be the core for any type of processor, such as a micro-processor, an embedded processor, a digital signal processor (DSP), a network processor, or other device to execute code. Although only one processor core 400 is illustrated in FIG. 16, a processing element may alternatively include more than one of the processor core 400 illustrated in FIG. 16. The processor core 400 may be a single-threaded core or, for at least one embodiment, the processor core 400 may be multithreaded in that it may include more than one hardware thread context (or “logical processor”) per core.

FIG. 16 also illustrates a memory 470 coupled to the processor core 400. The memory 470 may be any of a wide variety of memories (including various layers of memory hierarchy) as are known or otherwise available to those of skill in the art. The memory 470 may include one or more code 413 instruction(s) to be executed by the processor core 400, wherein the code 413 may include an ISA such as, for example, the ISA 306 (FIG. 14) to issue one or more instructions to conduct one or more hash operations on a hash table. The processor core 400 follows a program sequence of instructions indicated by the code 413. Each instruction may enter a front end portion 410 and be processed by one or more decoders 420. The decoder 420 may generate as its output a micro operation such as a fixed width micro operation in a predefined format, or may generate other instructions, microinstructions, or control signals which reflect the original code instruction. The illustrated front end portion 410 also includes register renaming logic 425 and scheduling logic 430, which generally allocate resources and queue the operation corresponding to the convert instruction for execution.

The processor core 400 is shown including execution logic 450 having a set of execution units 455-1 through 455-N. Some embodiments may include a number of execution units dedicated to specific functions or sets of functions. Other embodiments may include only one execution unit or one execution unit that can perform a particular function. The illustrated execution logic 450 performs the operations specified by code instructions.

After completion of execution of the operations specified by the code instructions, back end logic 460 retires the instructions of the code 413. In one embodiment, the processor core 400 allows out of order execution but requires in order retirement of instructions. Retirement logic 465 may take a variety of forms as known to those of skill in the art (e.g., re-order buffers or the like). In this manner, the processor core 400 is transformed during execution of the code 413, at least in terms of the output generated by the decoder, the hardware registers and tables utilized by the register renaming logic 425, and any registers (not shown) modified by the execution logic 450.

Although not illustrated in FIG. 16, a processing element may include other elements on chip with the processor core 400. For example, a processing element may include memory control logic along with the processor core 400. The processing element may include I/O control logic and/or may include I/O control logic integrated with memory control logic. The processing element may also include one or more caches.

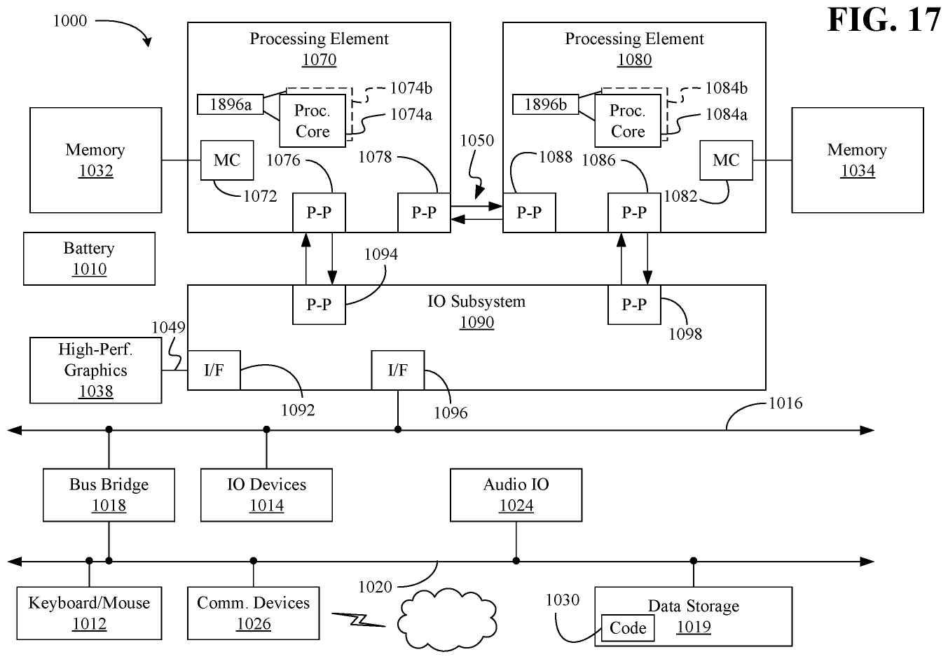

Referring now to FIG. 17, shown is a block diagram of a computing system 1000 embodiment in accordance with an embodiment. Shown in FIG. 17 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 17 may be implemented as a multi-drop bus rather than point-to-point interconnect.

As shown in FIG. 17, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 16.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 17, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 17, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 17, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may include an ISA such as, for example, the ISA 306 (FIG. 14) to issue one or more instructions to conduct one or more hash operations on a hash table. Further, an audio I/O 1024 may be coupled to second bus 1020 and a battery 1010 may supply power to the computing system 1000.

Note that other embodiments are contemplated. For example, instead of the point-to-point architecture of FIG. 17, a system may implement a multi-drop bus or another such communication topology. Also, the elements of FIG. 17 may alternatively be partitioned using more or fewer integrated chips than shown in FIG. 17.

### ADDITIONAL NOTES AND EXAMPLES

Example 1 includes a computing system comprising a network controller, a plurality of dynamic random access memories (DRAMs), and a processor coupled to the network controller, the processor including logic coupled to one or more substrates, wherein the logic includes a plurality of hash management buffers corresponding to a plurality of pipelines, wherein each hash management buffer in the plurality of hash management buffers is adjacent to a pipeline in the plurality of pipelines, and wherein a first hash management buffer is to issue one or more hash packets associated with one or more hash operations on a hash table, and a plurality of hash engines corresponding to the plurality of DRAMs, wherein each hash engine in the plurality of hash engines is adjacent to a DRAM in the plurality of DRAMs, and wherein one or more of the hash engines is to initialize a target memory destination associated with the hash table and conduct the one or more hash operations in response to the one or more hash packets.

Example 2 includes the computing system of Example 1, wherein the one or more hash operations includes an insert operation to insert a key-value pair into the target memory destination associated with the hash table.

Example 3 includes the computing system of Example 1, wherein the one or more hash operations includes a lookup operation to determine whether a key exists in the target memory destination associated with the hash table.

Example 4 includes the computing system of Example 1, wherein the one or more hash operations includes a delete operation to delete a key from the target memory destination associated with the hash table.

Example 5 includes the computing system of any one of Examples 1 to 4, wherein the one or more hash operations includes an unlock operation to unlock a key-value pair matching a key associated with the hash table.

Example 6 includes a semiconductor apparatus comprising one or more substrates, and logic coupled to the one or more substrates, wherein the logic is implemented at least partly in one or more of configurable or fixed-functionality hardware, the logic including a plurality of hash management buffers corresponding to a plurality of pipelines, wherein each hash management buffer in the plurality of hash management buffers is adjacent to a pipeline in the plurality of pipelines, and wherein a first hash management buffer is to issue one or more hash packets associated with one or more hash operations on a hash table, and a plurality of hash engines corresponding to a plurality of dynamic random access memories (DRAMs), wherein each hash engine in the plurality of hash engines is adjacent to a DRAM in the plurality of DRAMs, and wherein one or more of the hash engines is to initialize a target memory destination associated with the hash table and conduct the one or more hash operations in response to the one or more hash packets.

Example 7 includes the semiconductor apparatus of Example 6, wherein the one or more hash operations includes an insert operation to insert a key-value pair into the target memory destination associated with the hash table.

Example 8 includes the semiconductor apparatus of Example 6, wherein the one or more hash operations includes a lookup operation to determine whether a key exists in the target memory destination associated with the hash table.

Example 9 includes the semiconductor apparatus of Example 6, wherein the one or more hash operations includes a delete operation to delete a key from the target memory destination associated with the hash table.

Example 10 includes the semiconductor apparatus of Example 6, wherein the one or more hash operations includes an unlock operation to unlock a key-value pair matching a key associated with the hash table.

Example 11 includes the semiconductor apparatus of any one of Examples 6 to 10, wherein the first hash management buffer is to stall forward execution of a thread in a first pipeline until the one or more hash operations have completed, and wherein the one or more hash operations are to be associated with a single hash identifier.

Example 12 includes the semiconductor apparatus of any one of Examples 6 to 10, wherein the first hash management buffer is to stall forward execution of a thread in a first pipeline until the one or more hash operations have completed, and wherein the one or more hash operations are to be associated with a plurality of hash identifiers.

Example 13 includes the semiconductor apparatus of any one of Examples 6 to 12, wherein the logic coupled to the one or more substrates includes transistor channel regions that are positioned within the one or more substrates.

Example 14 includes a method of operating a performance-enhanced computing system, the method comprising issuing, by a first hash management buffer in a plurality of hash management buffers, one or more hash packets associated with one or more hash operations on a hash table, wherein each hash management buffer in the plurality of hash management buffers is to be adjacent to a pipeline in a plurality of pipelines, initializing, by one or more hash engines in a plurality of hash engines, a target memory destination associated with the hash table, wherein the plurality of hash engines corresponds to a plurality of dynamic random access memories (DRAMs), and wherein each hash engine in the plurality of hash engines is to be adjacent to a DRAM in the plurality of DRAMs, and conducting, by the one or more hash engines in the plurality of hash engines, the one or more hash operations in response to the one or more hash packets.

Example 15 includes the method of Example 14, wherein the one or more hash operations includes an insert operation to insert a key-value pair into the target memory destination associated with the hash table.

Example 16 includes the method of Example 14, wherein the one or more hash operations includes a lookup operation to determine whether a key exists in the target memory destination associated with the hash table.

Example 17 includes the method of Example 14, wherein the one or more hash operations includes a delete operation to delete a key from the target memory destination associated with the hash table.

Example 18 includes the method of any one of Examples 14 to 17, wherein the one or more hash operations includes an unlock operation to unlock a key-value pair matching a key associated with the hash table.

Example 19 includes the method of any one of Examples 14 to 18, wherein the first hash management buffer stalls forward execution of a thread in a first pipeline until the one or more hash operations have completed, and wherein the one or more hash operations are associated with a single hash identifier.

Example 20 includes the method of any one of Examples 14 to 18, wherein the first hash management buffer stalls forward execution of a thread in a first pipeline until the one or more hash operations have completed, and wherein the one or more hash operations are associated with a plurality of hash identifiers.

Example 21 includes an apparatus comprising means for performing the method of any one of Examples 14 to 20.

The technology described herein therefore achieves enhanced performance even when a high number of key-value pairs are being scanned for a single hash operation. The technology described herein also eliminates excess memory accesses to multiple memory lines when deleting hash table entries and managing the pointers linking to the various entries of the hash table. The technology described herein is also viable in highly-scalable systems targeting large datasets.

Embodiments may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Moreover, a semiconductor apparatus (e.g., chip, die, package) can include one or more substrates (e.g., silicon, sapphire, gallium arsenide) and logic (e.g., circuitry, transistor array and other integrated circuit/IC components) coupled to the substrate(s), wherein the logic implements one or more aspects of the methods described herein. The logic may be implemented at least partly in configurable or fixed-functionality hardware. In one example, the logic includes transistor channel regions that are positioned (e.g., embedded) within the substrate(s). Thus, the interface between the logic and the substrate(s) may not be an abrupt junction. The logic may also be considered to include an epitaxial layer that is grown on an initial wafer of the substrate(s).

We claim:

1. A computing system comprising:
a network controller;
a plurality of dynamic random access memories (DRAMs); and
a processor coupled to the network controller, the processor including logic coupled to one or more substrates, wherein the logic includes:
a plurality of hash management buffers corresponding to a plurality of pipelines, wherein each hash management buffer in the plurality of hash management buffers is adjacent to a pipeline in the plurality of pipelines, and wherein a first hash management buffer is to issue one or more hash packets associated with one or more hash operations on a hash table; and
a plurality of hash engines corresponding to the plurality of DRAMs, wherein each hash engine in the plurality of hash engines is adjacent to a DRAM in the plurality of DRAMs, and wherein one or more of the hash engines is to initialize a target memory destination associated with the hash table and conduct the one or more hash operations in response to the one or more hash packets.

2. The computing system of claim 1, wherein the one or more hash operations includes an insert operation to insert a key-value pair into the target memory destination associated with the hash table.

3. The computing system of claim 1, wherein the one or more hash operations includes a lookup operation to determine whether a key exists in the target memory destination associated with the hash table.

4. The computing system of claim 1, wherein the one or more hash operations includes a delete operation to delete a key from the target memory destination associated with the hash table.

5. The computing system of claim 1, wherein the one or more hash operations includes an unlock operation to unlock a key-value pair matching a key associated with the hash table.

6. A semiconductor apparatus comprising:
one or more substrates; and
logic coupled to the one or more substrates, wherein the logic is implemented at least partly in one or more of configurable or fixed-functionality hardware, the logic including:
a plurality of hash management buffers corresponding to a plurality of pipelines, wherein each hash management buffer in the plurality of hash management buffers is adjacent to a pipeline in the plurality of pipelines, and wherein a first hash management buffer is to issue one or more hash packets associated with one or more hash operations on a hash table; and
a plurality of hash engines corresponding to a plurality of dynamic random access memories (DRAMs), wherein each hash engine in the plurality of hash engines is adjacent to a DRAM in the plurality of DRAMs, and wherein one or more of the hash engines is to initialize a target memory destination associated with the hash table and conduct the one or more hash operations in response to the one or more hash packets.

7. The semiconductor apparatus of claim 6, wherein the one or more hash operations includes an insert operation to insert a key-value pair into the target memory destination associated with the hash table.

8. The semiconductor apparatus of claim 6, wherein the one or more hash operations includes a lookup operation to determine whether a key exists in the target memory destination associated with the hash table.

9. The semiconductor apparatus of claim 6, wherein the one or more hash operations includes a delete operation to delete a key from the target memory destination associated with the hash table.

10. The semiconductor apparatus of claim 6, wherein the one or more hash operations includes an unlock operation to unlock a key-value pair matching a key associated with the hash table.

11. The semiconductor apparatus of claim 6, wherein the first hash management buffer is to stall forward execution of a thread in a first pipeline until the one or more hash operations have completed, and wherein the one or more hash operations are to be associated with a single hash identifier.

12. The semiconductor apparatus of claim 6, wherein the first hash management buffer is to stall forward execution of a thread in a first pipeline until the one or more hash operations have completed, and wherein the one or more hash operations are to be associated with a plurality of hash identifiers.

13. The semiconductor apparatus of claim 6, wherein the logic coupled to the one or more substrates includes transistor channel regions that are positioned within the one or more substrates.

14. A method of operating a performance-enhanced computing system, the method comprising:
issuing, by a first hash management buffer in a plurality of hash management buffers, one or more hash packets associated with one or more hash operations on a hash table, wherein each hash management buffer in the plurality of hash management buffers is to be adjacent to a pipeline in a plurality of pipelines;
initializing, by one or more hash engines in a plurality of hash engines, a target memory destination associated with the hash table, wherein the plurality of hash engines corresponds to a plurality of dynamic random access memories (DRAMs), and wherein each hash engine in the plurality of hash engines is to be adjacent to a DRAM in the plurality of DRAMs; and
conducting, by the one or more hash engines in the plurality of hash engines, the one or more hash operations in response to the one or more hash packets.

15. The method of claim 14, wherein the one or more hash operations includes an insert operation to insert a key-value pair into the target memory destination associated with the hash table.

16. The method of claim 14, wherein the one or more hash operations includes a lookup operation to determine whether a key exists in the target memory destination associated with the hash table.

17. The method of claim 14, wherein the one or more hash operations includes a delete operation to delete a key from the target memory destination associated with the hash table.

18. The method of claim 14, wherein the one or more hash operations includes an unlock operation to unlock a key-value pair matching a key associated with the hash table.

19. The method of claim 14, wherein the first hash management buffer stalls forward execution of a thread in a first pipeline until the one or more hash operations have completed, and wherein the one or more hash operations are associated with a single hash identifier.

20. The method of claim 14, wherein the first hash management buffer stalls forward execution of a thread in a first pipeline until the one or more hash operations have completed, and wherein the one or more hash operations are associated with a plurality of hash identifiers.
